(19) United States
(12) Patent Application Publication
(10) Pub. No.: US 2016/0347009 A1
(43) Pub. Date: Dec. 1, 2016

(54) METHOD OF MANUFACTURING A FIBROUS MATERIAL PREIMPREGNATED WITH THERMOPLASTIC POLYMER USING AN AQUEOUS DISPERSION OF POLYMER

(71) Applicant: ARKEMA FRANCE, Colombes (FR)

(72) Inventors: Patrice GAILLARD, Hagetaubin (FR); Gilles HOCHSTETTER, L'Hay Les Roses (FR); Thibaut SAVART, Lacanau de Mios (FR)

(73) Assignee: ARKEMA FRANCE, Colombes (FR)

(21) Appl. No.: 15/117,312

(22) PCT Filed: Feb. 11, 2015
(86) PCT No.: PCT/FR2015/050332

§ 371 Date: Aug. 8, 2016

(30) Foreign Application Priority Data
Feb. 13, 2014 (FR) FR1451138

(51) Int. Cl. B29C 70/50; B29B 15/12

(52) U.S. Cl. CPC B29C 70/504; B29B 15/125; B29K 2101/12

(57) ABSTRACT

A method of manufacturing a pre-impregnated fibrous material produced as a plurality of unidirectional parallel tapes, said method including the following steps: i) impregnation of the fibrous material while it is in the form of several parallel rovings, said impregnation step including: ia) immersion in a bath containing an aqueous dispersion of thermoplastic polymer, said immersion being followed by ib) drying, then ii) shaping by calendering, using at least one heated calender, into the form of a plurality of unidirectional parallel tapes using said calender including a plurality of calendering grooves according to the number of said tapes and with a pressure and/or separation between the rolls of said calender regulated by a control system.

### FIELD OF THE INVENTION

The present invention concerns a method of producing a fibrous material pre-impregnated with thermoplastic polymer.

More particularly, the invention relates to a method for producing a pre-impregnated fibrous material comprising an impregnation step followed by a forming step to obtain ribbons of pre-impregnated fibrous material, of calibrated size, able to be directly used for the manufacture of three-dimensional composite parts.

In the present description, by “fibrous material” is meant an assembly of reinforcing fibres. Before forming, it is in the form of roving. After forming, it is in the form of strips or sheets or piece-form. If the reinforcing fibres are continuous, the assembly thereof forms a fabric. If the fibres are short, the assembly thereof forms a felt or non-woven.

Those fibres able to be included in the composition of fibrous materials are more especially carbon fibres, glass fibres, basalt fibres, silicon carbide fibres, polymerbased fibres, plant fibres or cellulose fibres used alone or in a mixture.

Such pre-impregnated fibrous materials are intended in particular for the production of light composite materials to manufacture mechanical parts having a three-dimensional structure, good mechanical strength and thermal properties, capable of evacuating electrostatic charges i.e. properties compatible with the manufacture of parts particularly in the following sectors: mechanical, aeronautical, nautical, automobile, energy, health and medical, military and armament, sports and leisure equipment and electronics.

Such pre-impregnated fibrous materials are also called composite materials. They comprise the fibrous material formed of reinforcing fibres and a matrix formed of the impregnating polymer. The primary role of this matrix is to maintain the reinforcing fibres in compact form and to impart the desired shape to the end product. Said matrix acts inter alia to protect the reinforcing fibres against abrasion and harsh environments, to control surface appearance and to disperse any charges between the fibres. This matrix plays a major role in the long-term resistance of the composite material, in particular regarding fatigue and creep.

### PRIOR ART

The good quality of the three-dimensional composite parts produced from pre-impregnated fibrous material therefore demands control first over the impregnating process of the reinforcing fibre with thermoplastic polymer and secondly over the forming of the pre-impregnated fibrous material into a semifinished product.

In the present description, the term “strip” is used to designate strips of fibrous material having a width of 100 mm or wider. The term “ribbon” is used to designate ribbons of calibrated width of 100 mm or less.

Up until the present time the production of strips of fibrous materials, reinforced by impregnating with thermoplastic polymer or thermosetting polymer, has been carried out using several processes depending in particular on the type of polymer, the type of desired end composite material and field of application. Powder deposit or molten polymer extrusion technologies are used to impregnate reinforcing fibres with thermosetting polymers e.g. epoxy resins such as described in patent WO2012/066241A2. In general, these technologies cannot be applied directly to impregnation with thermoplastic polymers, in particular those with high melting temperature the viscosity of which in the molten state is too high to obtain satisfactory impregnation of the fibres and good quality semifinished or finished products.

Some companies market strips of fibrous materials obtained using a method to impregnate unidirectional fibres via continuous drawing of the fibres through a bath of molten thermoplastic polymer containing an organic solvent such as benzophenone. Reference can be made for example to document U.S. Pat. No. 4,541,884 by Imperial Chemical Industries. The presence of the organic solvent particularly allows adapting of the viscosity of the molten mixture and ensures good coating of the fibres. The fibres thus impregnated are then formed. For example they can be cut up into strips of different widths, placed under a press and heated to a temperature above the melting temperature of the polymer to ensure cohesion of the material and in particular adhesion of the polymer to the fibres. This impregnation and forming method allows structural parts to be obtained having high mechanical strength.

One of the disadvantages of this technique lies in the heating temperature required to obtain these materials. The melting temperature of the polymers is notably dependent upon their chemical nature. It may be relatively high for polymers of polymethyl methacrylate type (PMMA), even very high for polymers of polyphenylene sulfide (PPS), polyether ether ketone (PEEK) or polyether ketone ketone (PEKK) type for example. The heating temperature may therefore reach a temperature higher than 250° C., and even higher than 350° C., these temperatures being far higher than the boiling point and flash point of the solvent which are 305° C. and 150° C. respectively for benzophenone. In this case, sudden departure of the solvent is observed leading to high porosity within the fibre and thereby causing the onset of defects in the composite material. The process is therefore difficult to reproduce and involves risks of explosion placing operators in danger. Finally the use of organic solvents is to be avoided for environmental, hygiene and operator safety reasons.

Document EP 0 406 067, filed jointly by Atochem and the French State, and document EP 0 201 367 describe an impregnation technique using a fluidised bed of polymer powder. The fibres enter a closed fluidisation tank where they come to be separated from one another by rollers or splined cylinders, the fibres being electrostatically charged via friction in contact with these rollers or cylinders. This electrostatic charge enables the polymer powder to adhere to the surface of the fibres and thereby impregnate the latter.

Another known impregnation method is the continuous passing of fibres through an aqueous dispersion of polymer powder. It is possible for example to refer to document EP0324680. In this process a dispersion of powders of micrometric size (about 20 μm) is used. After being immersed in the aqueous solution, the fibres are impregnated with the polymer powder. The process therefore entails a drying step to place the impregnated fibres in a first oven to evaporate the water absorbed during immersion. A heat treatment step to pass the dried impregnated fibres through a second heating zone at high temperature is then needed to melt the polymer so that it adheres, is distributed and coats the fibres.

The major drawback of this method is the homogeneity of the deposit which is often imperfect. Another problem related to this process is the high porosity induced by poor distribution of the polymer within the fibres, which may persist after the heat treatment step, resulting in the onset of a large number of defects in the pre-impregnated fibrous material. The pre-impregnated fibrous material then needs to be formed into ribbons for example. The forming technique may also further deteriorate and weaken the material through the presence of these defects.

Document FR2973802 describes a method to produce a composite material containing fibres and a polyvinyl chloride. In this method, at a first stage, the fibres are immersed in a hydrosol bath formed of an aqueous dispersion of polyvinyl chloride. The impregnated fibres are then dried to remove water and the hydrosol is gelled to change from a heterogeneous to a homogenous phase under the action of heat. This document does not disclose the impregnating of several parallel fibre ravings simultaneously in an aqueous dispersion and the forming thereof into parallel unidirectional ribbons by means of a heating calender with multiple grooves.

Document WO2008/051756 describes an aqueous dispersion of thermoplastic polymer powder used to impregnate fibre strands. Once impregnated, the fibres are dried to remove water and then transformed to granules or flakes. This document also does not disclose the impregnating of several parallel fibre rovings simultaneously in an aqueous dispersion and the forming thereof into parallel unidirectional ribbons by means of a heating calender with multiple grooves.

With regard to the forming of pre-impregnated fibrous materials into calibrated ribbons adapted for the manufacture of three-dimensional composite parts by automated fibre placement, this is generally performed post-treatment.

The quality of ribbons in pre-impregnated fibrous material and hence the quality of the end composite material depends not only on the homogeneity of fibre impregnation and hence on the control over and reproducibility of the porosity of the pre-impregnated fibrous material, but also on the size and more particularly the width and thickness of the ribbons. Regularity and control over these two dimensional parameters would allow an improvement in the mechanical strength of the materials.

At the current time, irrespective of the process used to impregnate fibrous materials, the manufacture of ribbons of narrow width i.e. having a width of less than 100 mm generally requires slitting (i.e. cutting) of strips more than 500 mm wide also known as sheets. The ribbons thus cut to size are then taken up for depositing by a robotic head.

In addition, since the rolls of sheet do not exceed a length in the order of 1 km, the ribbons obtained after cutting are generally not sufficiently long to obtain some materials of large size produced by automated fibre deposition. The ribbons must therefore be stubbed to obtain a longer length, thereby creating over thicknesses. These over-thicknesses lead to the onset of heterogeneities which are detrimental to obtaining composite materials of good quality.

Current techniques to impregnate fibrous materials and to form such pre impregnated fibrous materials into calibrated ribbons therefore have several disadvantages. It is difficult for example to heat a molten mixture of thermoplastic polymers homogeneously inside a die, when it leaves the die and far as the core of the material, which deteriorates the quality of impregnation. In addition, the difference in temperature existing between the fibres and a molten mixture of polymers at the impregnating die also deteriorates the quality and homogeneity of impregnation. The use of organic solvents generally implies the onset of defects in the material and environmental and safety risks. The forming at post-treatment and at high temperature of the pre-impregnated fibrous material into strips remains difficult since it does not always allow homogenous distribution of the polymer within the fibres which leads to obtaining material of lesser quality, The slitting of sheet to obtain calibrated ribbons and stubbing of these ribbons give rise to additional production costs. Slitting also generates major dust problems which pollute the ribbons of pre impregnated fibrous materials used for automated deposit and can lead to robot ill functioning and/or imperfections in the composites. This potentially leads to robot repair costs, stoppage of production and discarding of nonconforming products. Finally, at the slitting step a non-negligible amount of fibres is deteriorated leading to loss of properties and in particular to a reduction in mechanical strength and conductivity of the ribbons in pre-impregnated fibrous material,

### TECHNICAL PROBLEM

It is therefore the objective of the invention to overcome at least one of the disadvantages of the prior art. In particular, the invention sets out to propose a method of producing a pre-impregnated fibrous material, associating an impregnation technique with a continuous forming technique, to avoid any post-treatment step of the fibrous material and to obtain a pre-impregnated fibrous material having homogeneous impregnation of the fibre and controlled dimensions, with controlled reproducible porosity, on which depends the performance of the end composite part.

### BRIEF DESCRIPTION OF THE INVENTION

For this purpose the subject of the invention is a method of producing a pre impregnated fibrous material comprising a fibrous material of continuous fibres and a thermoplastic polymer matrix, characterized in that said pre-impregnated fibrous material is produced in a single unidirectional ribbon or a plurality of parallel unidirectional ribbons and in that said method comprises the following steps:
i. an impregnation step of said fibrous material in the form of a roving or several parallel ravings, said impregnation step comprising:
   ia) immersion of said fibrous material in a bath containing an aqueous dispersion of said thermoplastic polymer, said immersion being followed by:
   ib) drying of said fibrous material, then
ii. a forming step of said roving or said parallel rovings of said fibrous material impregnated at step i), via calendering by means of at least one heating calender, into the form of a single unidirectional ribbon or a plurality of parallel unidirectional ribbons and in the latter case said heating calender comprises a plurality of calendering grooves, preferably up to 200 calendering grooves conforming to the number of said ribbons, the pressure and/or spacing between the rollers of said calender being regulated by a servo system.

Therefore the hot calendering of the pre-impregnated roving(s), just downstream of the continuous impregnation device via immersion in a bath containing an aqueous polymer dispersion, allows homogenised distribution of the polymer and impregnation of the fibres, provides control over and reduces porosities within the pre-impregnated fibrous material and allows the obtaining of one or more ribbons of long length, wide width and calibrated thickness. With the method of the invention it is therefore possible to avoid the use of molten polymer having viscosity that is too high and the detrimental use of organic solvents, and it also allows the forming of ribbons of calibrated dimensions without having recourse to a slitting or stubbing step.

According to other optional characteristics of the method:
it further comprises a step iii) of spooling said ribbon(s) on one or more spools, the number of spools being identical to the number of ribbons, one spool being allocated to each ribbon;
said impregnation step i) is completed by a coating step of said single roving or said plurality of parallel ravings after the immersion ia) and drying ib) steps, with a molten thermoplastic polymer which may be the same or different from said thermoplastic polymer, said aqueous dispersion, said coating step being performed before said calendering step ii), said molten polymer preferably being of same type as said polymer of said aqueous dispersion, preferably said coating being performed via crosshead extrusion relative to said single roving or said plurality of parallel rovings;
said polymer of said aqueous dispersion is a thermoplastic polymer or mixture of thermoplastic polymers;
said thermoplastic polymer or mixture of thermoplastic polymers further comprises carbon fillers, in particular carbon black or carbon nanofillers, preferably selected from among carbon nanofillers, in particular graphenes and/or carbon nanotubes and/or carbon nanofibrils or mixtures thereof;
the thermoplastic polymer or mixture of thermoplastic polymers further comprises liquid crystal polymers or cyclic polybutylene terephthalate, or mixtures containing the same, as additive;
said thermoplastic polymer, or mixture of thermoplastic polymers, is selected from among amorphous polymers having a glass transition temperature such that Tg≧80° C. and/or from among semi-crystalline polymers having a melting temperature Tf≧150° C.,
the thermoplastic polymer or mixture of thermoplastic polymers is selected from among: polyaryl ether ketones (PAEK), in particular polyether ether ketone (PEEK); polyaryl ether ketone ketones (PAEKK), in particular polyether ketone ketone (PEKK); aromatic polyetherimides (PEI); polyaryl sulfones, in particular polyphenylene sulfones (PPSU); polyarylsulfides, in particular polyphenylene sulfides (PPS); polyamides (PA), in particular aromatic polyamides optionally modified by urea units; polyacrylates in particular polymethyl methacrylate (PMMA); or fluorinated polymers, in particular polyvinylidene fluoride (PVDF); and the mixtures thereof;
said fibrous material comprises continuous fibres selected from among carbon, glass, silicon carbide, basalt, silica fibres, natural fibres in particular flax or hemp, sisal, silk or cellulose fibres in particular viscose, or thermoplastic fibres having a glass transition temperature Tg higher than the Tg of said polymer or said mixture of polymers when the latter are amorphous, or has a melting temperature Tf higher than the Tf of said polymer or said mixture of polymers when the latter are semi-crystalline, or a mixture of two or more of said fibres, preferably a mixture of carbon, glass or silicon carbide fibres, in particular carbon fibres;
the volume percentage of said polymer or mixture of polymers relative to said fibrous material varies from 40 to 250%, preferably from 45 to 125% and more preferably from 45 to 80%;
the volume percentage of said polymer or said mixture of polymers relative to said fibrous material varies from 0.2 to 15%, preferably between 0.2 and 10% and more preferably between 0.2 and 5%;
the calendering step ii) is performed using a plurality of heating calenders;
said heating calender(s) at step ii) comprise an integrated heating system via induction or microwave, preferably via microwave, combined with the presence of carbon fillers in said thermoplastic polymer or mixture of thermoplastic polymers;
said heating calender(s) at step ii) are coupled to an additional rapid heating device, positioned before and/or after said (each) calender, in particular a microwave or induction heating device combined with the presence of carbon fillers in said polymer or in said mixture of polymers, or an infrared IR or Laser heating device, or via direct contact with another heat source such as a flame.

The invention also relates to a unidirectional ribbon of pre-impregnated fibrous material, in particular a ribbon wound on a spool, characterized in that it is obtained by a method such as defined above.

According to one optional characteristic, the width and thickness of the ribbon are adapted for depositing by a robot for the manufacture of three-dimensional parts, without the need for slitting, and preferably this width is at least 5 mm possibly reaching 100 mm, more preferably from 5 to 50 mm and further preferably from 5 to 10 mm.

The invention also relates to utilisation of the method such as defined above for the production of calibrated ribbons adapted to the manufacture of three dimensional composite parts via automated deposit of said ribbons by a robot.

The invention also relates to utilisation of the ribbon such as defined above for the manufacture of three-dimensional composite parts. Said manufacture of said composite parts concerns the transport sectors, in particular automobile, civil or military aviation, nautical, rail; renewable energies in particular wind, hydrokinetic; energy storage systems, solar panels; thermal protection panels; sports and leisure equipment, health and medicine; ballistics with parts for weapons or missiles; safety and electronics.

The invention also concerns a three-dimensional composite part, characterized in that it results from the use of at least one unidirectional ribbon in pre impregnated fibrous material such as defined above.

Finally, the invention is directed towards a unit for implementing the production method such as defined above, said unit being characterized in that it comprises:
a) a device for continuous impregnation comprising:
   a1) an immersion tank containing said aqueous dispersion of said polymer, and
   a2) a device to dry said single roving or said plurality of parallel rovings,
b) a device for continuous calendering of said roving or said parallel rovings, with forming into a single ribbon or into several parallel unidirectional ribbons, comprising:
   b1) at least one heating calender, in particular several heating calenders in series, said calender having a calendering groove or several calendering grooves and preferably in this latter case having up to 200 calendering grooves;
   b2) a system for regulating pressure and/or spacing between calender rollers.

According to other optional characteristics of the unit:
it further comprises a device to spool the ribbons of pre-impregnated fibrous material, comprising an identical number of spools to the number of ribbons, one spool being allocated to each ribbon;
said impregnation device a), following after said immersion tank device a1) and said drying device a2), additionally comprises a device a3) to coat said impregnated and dried single roving or said plurality of parallel rovings, with a molten polymer, preferably said coating device a3) comprising a crosshead extrusion device relative to said single roving or relative to said parallel rovings;
said heating calender(s) comprise an integrated induction heating system;
said heating calender(s) are coupled to an additional rapid heating device positioned before and/or after said (each) calender, said heating system being selected from among a microwave or induction device in particular when combined with the presence of carbon fillers, or an IR or Laser heating system or other device allowing direct contact with a heat source, such as a flame device;
said drying device, positioned at the exit of said immersion tank, is a heating device selected from among a microwave or induction device, in particular when combined with the presence of carbon fillers, or an infrared IR heating system or water vapour extraction oven.

Other particular aspects and advantages of the invention will become apparent on reading the description that is non-limiting and given for illustrative purposes, with reference to the appended Figures illustrating:

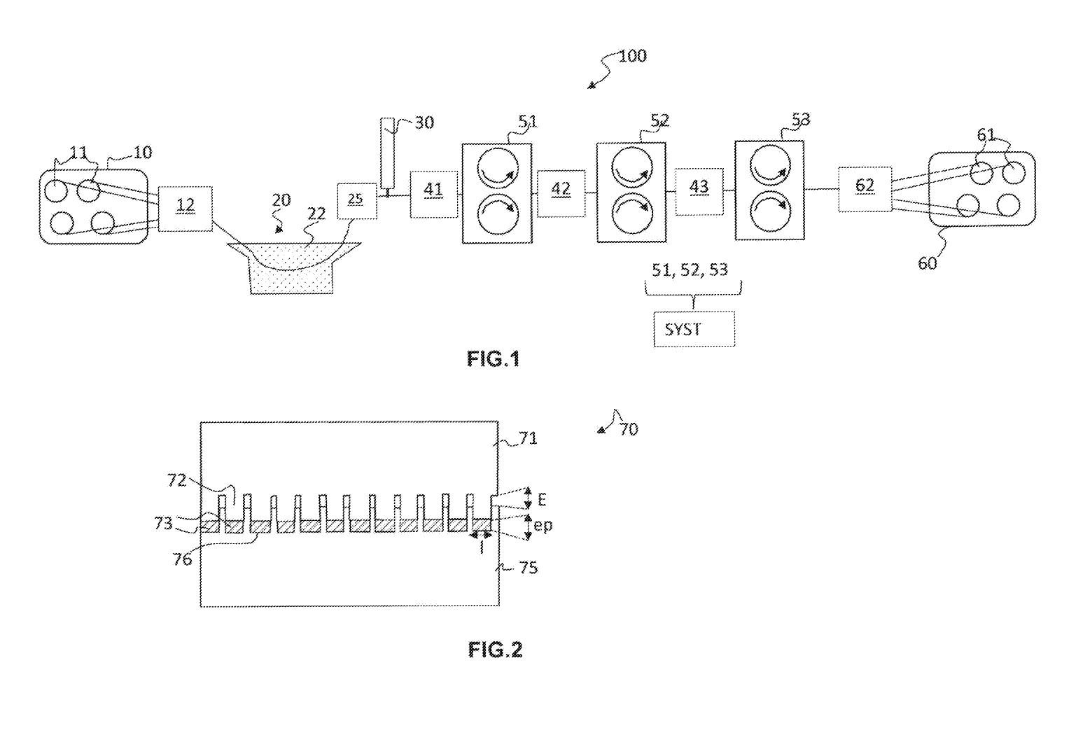

FIG. 1, a schematic of a unit to implement the method of producing a pre impregnated fibrous material according to the invention;

FIG. 2, a cross-sectional schematic of two constituent rollers of a calender such as used in the unit in FIG. 1,

### DETAILED DESCRIPTION OF THE INVENTION

The term “aqueous dispersion” such as used relates to any polymer dispersion in an aqueous medium, comprising emulsion, suspension including micro suspension, of a powder of polymer(s) or dispersion of polymer particles formed in situ during polymerisation in an aqueous medium e.g. via emulsion or suspension polymerisation.

### Polymer Matrix

By thermoplastic or thermoplastic polymer is meant a material generally solid at ambient temperature, possibly being crystalline, semi-crystalline or amorphous, which softens on temperature increase, in particular after passing its glass transition temperature (Tg) if it is amorphous, flows at higher temperature and may melt without any phase change when it passes its melting temperature (Tf) (if it is crystalline or semi-crystalline); it returns to the solid state when the temperature drops to below its melting temperature and below its glass transition temperature.

With regard to the constituent polymer of the fibrous material impregnation matrix, it is advantageously a thermoplastic polymer or mixture of thermoplastic polymers. This thermoplastic polymer or mixture of thermoplastic polymers is ground to a powder so that it can be used in an aqueous dispersion. The powder particles preferably have a mean diameter of less than 125 μm so that they can penetrate the fibre roving(s).

Optionally, the thermoplastic polymer or mixture of thermoplastic polymers further comprises carbon fillers, carbon black in particular or carbon nanofillers, preferably selected from among carbon nanofillers in particular graphenes and/or carbon nanotubes and/or carbon nanofibrils or the mixtures thereof. These fillers allow conducting of electricity and heat and therefore allow improved lubrication of the polymer matrix when it is heated.

According to another variant, the thermoplastic polymer or mixture of thermoplastic polymers may further comprise additives such a liquid crystal polymers or cyclic polybutylene terephthalate, or mixtures containing the same such as CBT100 resin marketed by CYCLICS CORPORATION. These additives particularly allow fluidisation of the polymer matrix in the molten state, for better penetration into the core of the fibres. Depending on the type of thermoplastic polymer or polymer mixture used to prepare the impregnation matrix, in particular the melting temperature thereof, one or other of these additives will be chosen.

Advantageously, the thermoplastic polymer, or mixture of thermoplastic polymers, is selected from among amorphous polymers having a glass transition temperature such that Tg≧80° C. and/or from among semi-crystalline polymers having a melting temperature Tf≧150° C.

More particularly, the thermoplastic polymers entering into the composition of the fibrous material impregnation matrix can be selected from among:
polymers and copolymers of the polyamide family (PA), such as high density polyamide, polyamide 6 (PA-6), polyamide 11 (PA-11), polyamide 12 (PA-12), polyamide 6.6 (PA-6.6), polyamide 4,6 (PA-4,6), polyamide 6.10 (PA-6.10), polyamide 6.12 (PA-6.12), aromatic polyamides, optionally modified by urea units, in particular polyphthalamides and aramid, and block copolymers in particular polyamide/polyether,
polyureas, aromatic in particular,
polymers and copolymers of the acrylic family such as polyacrylates, and more particularly polymethyl methacrylate (PMMA) or the derivatives thereof,
polymers and copolymers of the polyarylether ketone family (PAEK) such as polyether ether ketone (PEEK), or polyarylether ketone ketones (PAEKK) such as polyether ketone ketone) (PEKK) or the derivatives thereof,
aromatic polyetherimides (PEI),
polyarylsulfides, in particular polyphenylene sulfides (PPS),
polyarylsulfones, in particular polyphenylene sulfones (PPSU),
polyolefins, in particular polypropylene (PP);
polylactic acid (PLA),
polyvinyl alcohol (PVA),
fluorinated polymers, in particular polyvinylidene fluoride (PVDF), or polytetrafluoroethylene (PTFE) or polychlorotrifluoroethylene (PCTFE),
and the mixtures thereof.

Preferably the constituent polymers of the matrix are selected from among thermoplastic polymers having a high melting temperature Tf, namely on and after 150° C., such as Polyamides (PA), in particular aromatic polyamides optionally modified by urea repeat units and the copolymers thereof, Polymethyl methacrylate (PPMA) and the copolymers thereof, Polyether imides (PEI), Polyphenylene sulfide (PPS), Polyphenylene sulfone (PPSU), Polyetherketoneketone (PEKK), Polyetheretherketone (PEEK), fluorinated polymers such as polyvinylidene fluoride (PVDF).

For fluorinated polymers, a homopolymer of vinylidene fluoride (VDF of formula CH₂═CF₂) can be used, or a VDF copolymer comprising at least 50 weight % VDF and at least one other monomer copolymerisable with VDF, The VDF content must be higher than 80 weight %, even better higher than 90 weight % to impart good mechanical strength to the structural part, especially when subjected to thermal stresses. The comonomer may be a fluorinated monomer such as vinyl fluoride for example.

For structural parts that are to withstand high temperatures, in addition to fluorinated polymers advantageous use can be made according to the invention of PAEKs (PolyArylEtherKetone) such as polyether ketones (PEK), polyether ether ketone (PEEK), polyether ketone ketone (PEKK), polyether ketone ether ketone ketone (PEKEKK), etc.

### Fibrous Material:

Regarding the constituent fibres of the fibrous material, these are fibres of mineral, organic or plant origin in pafticular. Among the fibres of mineral origin, mention can be made of carbon fibres, glass fibres, basalt fibres, silica fibres or silicon carbide fibres for example. Among the fibres of organic origin, mention can be made of fibres containing a thermoplastic or thermosetting polymer such as aromatic polyamide fibres, aramid fibres or polyolefin fibres for example, Preferably they are thermoplastic polymerbased and have a glass transition temperature Tg higher than the Tg of the constituent thermoplastic polymer or thermoplastic polymer mixture of the impregnation matrix if the polymer(s) are amorphous, or a melting temperature Tf higher than the Tf of the constituent thermoplastic polymer or thermoplastic polymer mixture of the impregnation matrix if the polymer(s) are semi-crystalline. There is therefore no risk of melting of the constituent organic fibres of the fibrous material. Among the fibres of plant origin, mention can be made of natural flax, hemp, silk in particularly spider silk, sisal fibres and other cellulose fibres particularly viscose, These fibres of plant origin can be used pure, treated or coated with a coating layer to facilitate adhesion and impregnation of the thermoplastic polymer matrix.

These constituent fibres can be used alone or in a mixture. For example, organic fibres can be mixed with mineral fibres for impregnation with thermoplastic polymer and to form the pre-impregnated fibrous material.

The chosen fibres can be single-strand, multi-strand or a mixture of both, and CaO have several gram weights, In addition they may have several geometries, They may therefore be in the form of short fibres, then producing felts or nonwovens in the form of strips, sheets, braids, ravings or pieces, or in the form of continuous fibres producing 2D fabrics, fibres or rovings of unidirectional fibres (UD) or nonwovens. The constituent fibres of the fibrous material may also be in the form of a mixture of these reinforcing fibres having different geometries. Preferably, the fibres are continuous.

Preferably, the fibrous material is composed of continuous fibres of carbon, glass or silicon carbide or a mixture thereof, in particular carbon fibres. It is used in the form of one or more rovings.

Depending on the volume ratio of polymer relative to the fibrous material, it is possible to produce so-called “ready-to-use” pre-impregnated materials or so-called “dry” pre-impregnated materials.

In so-called “ready-to-use” pre-impregnated materials, the thermoplastic polymer or polymer mixture is uniformly and homogeneously distributed around the fibres. In this type of material, the impregnating thermoplastic polymer must be distributed as homogenously as possible within the fibres to obtain minimum porosities i.e. voids between the fibres. The presence of porosities in this type of material may act as stress-concentrating points when subjected to a mechanical tensile stress for example and then form rupture initiation points in the pre-impregnated fibrous material causing mechanical weakening. Homogeneous distribution of the polymer or polymer mixture therefore improves the mechanical strength and homogeneity of the composite material produced from these pre-impregnated fibrous materials.

Therefore, with regard to so-called “ready-to-use” pre-impregnated materials, the volume percentage of thermoplastic polymer or polymer mixture relative to the fibrous material varies from 40 to 250%, preferably from 45 to 125%, and more preferably from 45 to 80%.

Socalled “dry” pre-impregnated fibrous materials comprise porosities between the fibres and a smaller amount of impregnating thermoplastic polymer coating the fibres on the surface to hold them together. These “dry” pre-impregnated materials are adapted for the manufacture of preforms for composite materials. These preforms can then be used for the infusion of thermoplastic resin or thermosetting resin for example. In this case, the porosities facilitate subsequent conveying of the infused polymer into the pre-impregnated fibrous material, to improve the end properties of the composite material and in particular the mechanical cohesion thereof. In this case, the presence of the impregnating thermoplastic polymer on the so-called “dry” fibrous material is conducive to compatibility of the infusion resin,

With regard to so-called “dry” pre-impregnated materials therefore, the volume percentage of polymer or mixture of polymers relative to the fibrous material advantageously varies from 0.2 to 15%, preferably between 0.2 and 10% and more preferably between 0.2 and 5%. In this case the term polymeric web is used having low gram weight, deposited on the fibrous material to hold the fibres together.

The method of producing a fibrous material according to the invention advantageously comprises two steps: a first step to impregnate the fibrous material with the thermoplastic polymer, followed by a step to form the pre-impregnated fibrous material into one or more unidirectional ribbons having calibrated width and thickness.

### Impregnation Step:

The production method and unit to implement this method are described below with reference to FIG. 1 which, in very simple manner, schematises the constituent elements of this unit 100.

Advantageously, the impregnation step of the fibrous material is performed by passing one or more rovings through a continuous impregnating device comprising an immersion tank 20 containing an aqueous dispersion of polymers (e.g. powder of thermoplastic polymer(s)). Said dispersion preferably has a mean particle size of between 0.3 and 125 μm.

Each roving to be impregnated is unwound from a reel 11 device 10, under traction generated by cylinders (not illustrated). Preferably the device 10 comprises a plurality of reels 11, each reel allowing the unwinding of one roving to be impregnated. It is therefore possible to impregnate several fibre rovings simultaneously. Each reel 11 is provide with a braking system (not illustrated) to tension each fibre roving. In this case an alignment module 12 allows the fibre rovings to be arranged parallel to one another. In this manner the fibre rovings cannot come into contact with each other, thereby particularly avoiding mechanical degradation of the fibres.

The fibre roving or parallel fibre rovings are then passed through the immersion tank 20 containing the aqueous polymer dispersion. The powder of polymer(s) is mixed with water to form this dispersion. The roving(s) are caused to circulate in the bath formed by this aqueous dispersion 22. The mean diameter of the polymer particles, including in the form of a powder dispersion, in the aqueous dispersion is preferably smaller than 125 μm, so that they can penetrate into the fibre roving(s). Preferably, the diameter of the particles is between 0.3 μm and 125 μm, more preferably between 0.4 μm and 100 μm. The pre-impregnated roving(s) then leave the tank 20 and are directed towards a drying device 25 for evaporation of water. This drying device 25, positioned after the immersion tank 20 is advantageously formed of a heating device selected from among a microwave or induction device, in particular when combined with the presence of carbon fillers, or an infrared IR heating system or water vapour extraction oven. Advantageously, if the polymer or mixture of polymers comprises carbon fillers, such as carbon black or carbon nanofillers, preferably selected from among carbon nanofillers in particular graphenes and/or carbon nanotubes and/or carbon nanofibrils or mixtures thereof, the heating effect via induction or microwave is amplified by the presence of these fillers which convey the heat as far as the core of the material.

Optionally, this impregnation step can be completed by a step to coat the pre-impregnated roving(s), immediately on leaving the impregnation tank 20 and drying device 25 and just before the forming step via calendering. For this purpose a coating device 30, preferably via crosshead extrusion, is used to coat the pre-impregnated fibre roving(s) with a molten thermoplastic polymer. The coating polymer may be the same or different from the polymer powder in aqueous dispersion. Preferably it is of same type. Said coating not only allows completion of the fibre impregnation step to obtain a final volume percentage of polymer within the desired range, in particular to obtain so-called “ready-to-use” fibrous materials of good quality, but also allows improvement in the performance of the composite material obtained.

### Forming Step

Immediately after leaving the drying device 25, the pre-impregnated roving or parallel rovings, optionally coated with molten polymer, are formed into a single unidirectional ribbon or into a plurality of parallel unidirectional ribbons, by means of a continuous calendering device comprising one or more heating calenders.

Up until the present time, hot calendering could not be envisaged for a forming step but only for a finishing step since it was not able to heat up to sufficient temperatures, in particular if the thermoplastic polymer or polymer mixture comprises polymers with a high melting temperature.

Advantageously, the heating calenders of the calendering device are coupled to rapid heating means which allow the material to be heated not only on the surface but also at the core. The mechanical stress of the calenders coupled to these rapid heating means allows porosities to be removed and the polymer to be distributed homogeneously, in particular if the fibrous material is a so-called “ready-to-use” material.

Advantageously, this hot calendering not only allows the impregnation polymer to be heated so that it penetrates into, adheres to and uniformly coats the fibres, but also provides control over the thickness and width of the ribbons of pre impregnated fibrous material,

To produce a plurality of parallel unidirectional ribbons i.e. as many ribbons as pre-impregnated parallel rovings passed through the aqueous dispersion bath 22, the heating calenders referenced 51, 52, 53 in the schematic in FIG. 1 advantageously comprise a plurality of calendering grooves conforming to the number of ribbons. This number of grooves may total up to 200 for example. A SYST servo system allows regulation of the pressure and/or of the spacing E between the rollers 71, 75 of the calender 70, so as to control the thickness ep of the ribbons. Said calender 70 is schematised in FIG. 2 described below.

The calendering device comprises at least one heating calender 51. Preferably it comprises several heating calenders 51, 52, 53 mounted in series. The fact that there are several calenders in series means that it is possible to compress the porosities and reduce the number thereof. This plurality of calenders is therefore of importance if it is desired to produce so-called “ready-to-use” fibrous materials.

On the other hand, to produce so-called “dry” fibrous materials, a fewer number of calenders will be sufficient, even a single calender.

Advantageously, each calender of the calendering device has an integrated heating system via induction or microwave, preferably microwave, to heat the thermoplastic polymer or polymer mixture. Advantageously if the polymer of polymer mixture comprises carbon fillers such as carbon black or carbon nanofillers, preferably selected from among carbon nanofillers in particular graphenes and/or carbon nanotubes and/or carbon nanofibrils or the mixtures thereof, the heating effect via induction or microwave is amplified by these fillers which then convey the heat into the core of the material.

Advantageously, each calender 51, 52, 53 of the device is coupled to a rapid heating device 41, 42, 43 positioned before and/or after each calender for rapid transmission of thermal energy to the material and for perfecting of fibre impregnation with said molten polymer. The rapid heating device can be selected for example from among the following devices: a microwave or induction device, an infrared IR or laser device or other device allowing direct contact with a heat source such as a flame device. A microwave or induction device is most advantageous, in particular when combined with the presence of carbon nanofillers in the polymer or polymer mixture since carbon nanofillers amplify the heating effect and transmit this effect to the core of the material.

According to one variant of embodiment it is also possible to combine several of these heating devices.

The method may further comprise a step to heat the fibre rovings before said impregnation using microwave heating as preferred heating means, as for the heating system of said heating calender.

Optionally, a subsequent step is to spool the pre-impregnated, formed ribbon(s). For this purpose a unit 100 to implement the method comprises a spooling device 60 comprising as many spools 61 as there are ribbons, one spool 61 being allocated to each ribbon. A distributor 62 is generally provided to direct the pre impregnated ribbons towards their respective spool 61 whilst preventing the ribbons from touching one another to prevent any degradation.

FIG. 2 schematises cross-sectional details of the groove 73 of a calender 70. A calender 70 comprises an upper roller 71 and a lower roller 75. One of the rollers e.g. the upper roller 71 comprises a castellated part 72, whilst the other roller i.e. the lower roller 75 in the example comprises a grooved part 76, the shape of the grooves matching the protruding parts 72 of the upper roller. The spacing E between the rollers 71, 75 and/or the pressure applied by the two rollers against one another allows defining of the dimensions of the grooves 73, and in particular the thickness ep thereof and width I. Each groove 73 is designed to house a fibre roving which is then pressed and heated between the rollers. The rovings are subsequently transformed into parallel unidirectional ribbons, the thickness and width of which are calibrated by the grooves 73 of the calenders. Each calender advantageously comprises a plurality of grooves the number of which may total up to 200, so that as many ribbons can be produced as there are grooves and pre-impregnated rovings. The calendering device also comprises a central device referenced SYST in FIG. 1, driven by a computer programme provided for this purpose and which allows simultaneous regulation of the pressure and/or spacing between the calender rollers of all the calenders 51, 52, 53 in the unit 100.

The unidirectional ribbon(s) thus produced have a width and thickness adapted for depositing by a robot for the manufacture of three-dimensional parts without the need for slitting. The width of the ribbon(s) is advantageously between 5 and 100 mm, preferably between 5 and 50 mm, and more preferably between 5 and 10 mm.

The method of producing a pre-impregnated fibrous material just described therefore allows pre-impregnated fibrous materials to be produced with high productivity whilst allowing homogeneous impregnation of the fibres, providing control over porosity which is reproducible and hence providing controlled, reproducible performance of the targeted end composite product. Homogeneous impregnation around the fibres and the absence of porosities are ensured by the impregnation step, via immersion in an aqueous polymer dispersion, coupled with the use of a forming device under mechanical loading itself coupled to rapid heating systems, thereby allowing heating of the material on the surface as well as at the core. The materials obtained are semifinished products in the form of ribbons with calibrated thickness and width used for the manufacture of three-dimensional structural parts in transport sectors such as automobile, aviation, nautical or rail; renewable energies in particular wind energy, hydrokinetic energy; energy storage devices, solar panels; thermal protection panels; sports and leisure equipment, health and medicine, weapons, weaponry and ballistics (parts for weapons or missiles), safety—using a method entailing the deposition of strips assisted by a robot head for example and known as Automatic Fibre Placement (AFP).

This method therefore allows the continuous manufacture of ribbons of calibrated size and long length, with the result that it avoids slitting and stubbing steps that are costly and detrimental to the quality of subsequently manufactured composite parts. The savings related to elimination of the slitting step represent about 30-40% of the total production cost of a ribbon of pre-impregnated fibrous material.

The association of rapid heating devices with the heating calenders facilitates forming of the ribbons to the desired dimensions, and allows a significant increase in the production rate of these ribbons compared with conventional forming methods. In addition this association allows densification of the material by fully eliminating the porosities in so-called “ready-to-use” fibrous materials.

The rapid heating devices also allow the use of numerous grades of polymers, even the most viscous, thereby covering all the desired ranges of mechanical strength.

For the specific manufacture of ribbons of so-called “dry” fibrous materials, the impregnation step via immersion in an aqueous dispersion, allows a polymer gram weight to be obtained that is homogenously distributed with a preferred content of deposited polymer in the order of 5 to 7 g/m.

The method therefore allows the production of calibrated ribbons of pre impregnated fibrous material adapted for the manufacture of three-dimensional composite parts via automated deposition of said ribbons.

1. A method of producing a pre-impregnated fibrous material comprising a fibrous material of continuous fibres and a thermoplastic polymer matrix, wherein said pre-impregnated fibrous material is produced in a plurality of parallel unidirectional ribbons, wherein said method comprises the following steps:
i) an impregnation step of said fibrous material in the form of several parallel rovings, said impregnation step comprising:
ia) immersion of said fibrous material in a bath containing an aqueous dispersion of said thermoplastic polymer, said immersion being followed by:
ib) drying of said fibrous material, then
ii) a forming step of said parallel rovings of said fibrous material impregnated at step i), via calendering by means of at least one heating calender (51, 52, 53), into the form of a plurality of parallel unidirectional ribbons, said heating calender comprising a plurality of calendering grooves, the pressure and/or spacing between the rollers of said calender being regulated by a servo system.

2. The method according to claim 1, wherein the method further comprises a step iii) of spooling said ribbons on several spools, the number of spools being identical to the number of ribbons, one spool being allocated to each ribbon.

3. The method according to claim 1, wherein said impregnation step i) is completed by a coating step of said plurality of parallel rovings after the immersion ia) and drying ib) steps, with a molten thermoplastic polymer which may be the same or different from said thermoplastic polymer of said aqueous dispersion, said coating step being performed before said calendering step ii), said molten polymer preferably being of same type as said polymer of said aqueous dispersion.

4. The method according to claim 1, wherein said polymer of said aqueous dispersion is a thermoplastic polymer or mixture of thermoplastic polymers.

5. The method according to claim 4, wherein said thermoplastic polymer or mixture of thermoplastic polymers further comprises carbon fillers.

6. The method according to claim 4, wherein the thermoplastic polymer or mixture of thermoplastic polymers further comprises liquid crystal polymers or cyclic polybutylene terephthalate, or mixtures containing the same, as additive.

7. The method according to claim 1, wherein said thermoplastic polymer, or mixture of thermoplastic polymers, is selected from among amorphous polymers having a glass transition temperature such that Tg≧80° C. and/or from among semi-crystalline polymers having a melting temperature Tf≧150° C.

8. The method according to claim 7, wherein the thermoplastic polymer or mixture of thermoplastic polymers is selected from among: polyaryl ether ketones; polyaryl ether ketone ketones; aromatic polyether-imides; polyaryl sulfones; polyarylsulfides; polyamides; polyacrylates; or fluorinated polymers; and the mixtures thereof.

9. The method according to claim 1, wherein said fibrous material comprises continuous fibres selected from among carbon, glass, silicon carbide, basalt, silica fibres, natural fibres, or thermoplastic fibres having a glass transition temperature Tg higher than the Tg of said polymer or said mixture of polymers when the latter are amorphous, or having a melting temperature Tf higher than the Tf of said polymer or said mixture of polymers when the latter are semi-crystalline, or a mixture of two or more of said fibres.

10. The method according to claim 1, wherein the volume percentage of said polymer or mixture of polymers relative to said fibrous material varies from 40 to 250%.

11. The method according to claim 1, wherein the volume percentage of said polymer or said mixture of polymers relative to said fibrous material varies from 0.2 to 15%

12. The method according to claim 1, wherein the calendering step ii) is performed using a plurality of heating calenders.

13. The method according to claim 1, wherein said heating calender(s) at step ii) comprise an integrated heating system via induction or microwave, combined with the presence of carbon fillers in said thermoplastic polymer or mixture of thermoplastic polymers.

14. The method according to claim 1, wherein said heating calender(s) at step ii) are coupled to an additional rapid heating device positioned before and/or after said (each) calender.

15. A unidirectional ribbon of pre-impregnated fibrous material obtained using the method defined in claim 1.

16. The ribbon according to claim 15, where the ribbon has a width and thickness adapted for depositing by a robot for the manufacture of three-dimensional parts, without the need for slitting.

17. A method producing calibrated ribbons by the method defined in claim 1, wherein the calibrated ribbons are adapted to the manufacture of three-dimensional composite parts via automated deposit of said ribbons by a robot.

18. A method of manufacturing a three dimensional composite part, the method comprising using the ribbon of pre-impregnated fibrous material defined in claim 15 for the manufacture of three-dimensional composite parts.

19. The method according to claim 18, wherein said manufacture of said composite parts concerns the transport sector; thermal protection panels; sports and leisure equipment, health and medicine; ballistics with parts for weapons or missiles; safety and electronics.

20. A three-dimensional composite part, wherein the part results from the use of at least one unidirectional ribbon of pre-impregnated fibrous material as defined in claim 15.

21. A unit for implementing the method defined in claim 1, wherein the unit comprises:
a) a device for continuous impregnation comprising:
a1) an immersion tank containing said aqueous dispersion of said polymer, and
a2) a device to dry said plurality of parallel rovings,
b) a device for continuous calendering of said parallel rovings, with forming into several parallel unidirectional ribbons, comprising:
b1) at least one heating calender, said calender having several calendering grooves;
b2) a system for regulating pressure and/or spacing between calender rollers.

22. The unit according to claim 21, wherein the unit further comprises a device for spooling the ribbons of pre-impregnated fibrous materials, comprising a number of spools identical to the number of ribbons, one spool being allocated to each ribbon.

23. The unit according to claim 21, wherein said impregnation device a) following after said immersion tank device a1), and said drying device a2), additionally comprises a device a3) to coat said plurality of impregnated, dried parallel ravings with a molten polymer.

24. The unit according to claim 21, wherein said heating calender(s) comprise an integrated heating system via induction.

25. The unit according to claim 21, wherein said heating calender(s) are coupled to an additional rapid heating device, positioned before and/or after said calender, said heating system being selected from among a microwave or induction device.

26. The unit according to claim 21, wherein said drying device, positioned at the exit of the immersion tank, is a heating device selected from among a microwave or induction device.
